(19) United States
(12) Patent Application Publication
(10) Pub. No.: US 2024/0169400 A1
(43) Pub. Date: May 23, 2024

(54) INFORMATION PROCESSING APPARATUS, INFORMATION PROCESSING METHOD, AND PROGRAM

(71) Applicant: NEC Corporation, Tokyo (JP)

(72) Inventor: Yoshiko IMANISHI, Tokyo (JP)

(73) Assignee: NEC Corporation, Tokyo (JP)

(21) Appl. No.: 18/504,702

(22) Filed: Nov. 8, 2023

(30) Foreign Application Priority Data
Nov. 18, 2022 (JP) 2022-185231

(51) Int. Cl. G06Q 30/0251

(52) U.S. Cl. CPC G06Q 30/0271

(57) ABSTRACT

Provided are an information processing apparatus, an information processing method, and a program that are capable of appropriately acquiring psychographic data of a user. An information processing apparatus includes a modification information acquisition unit configured to acquire modification information being information related to modification of an avatar, a data estimation unit configured to estimate psychographic data of a user of the avatar, based on the acquired modification information, and a data output unit configured to output the estimated psychographic data.

### INCORPORATION BY REFERENCE

This application is based upon and claims the benefit of priority from Japanese patent application No. 2022-185231, filed on Nov. 18, 2022, the disclosure of which is incorporated herein in its entirety by reference.

### TECHNICAL FIELD

The present disclosure relates to an information processing apparatus, an information processing method, and a program.

### BACKGROUND ART

In recent years, in e-commerce and the like, personalized marketing using psychographic data representing a user's preference and the like has been performed. However, when information such as a service use history of the user cannot be acquired, it is difficult to acquire the psychographic data of the user from such information. In addition, it is not preferable to perform a questionnaire survey on a user and acquire psychographic data since it is a burden on the user. In this regard, Japanese Unexamined Patent Application Publication No. 2006-30482 discloses determining a preference of a user according to which of options of personal effects of an avatar is selected by the user.

### SUMMARY

In the technique described in Japanese Unexamined Patent Application Publication No. 2006-30482, a user's operation of selecting one of options of personal effects is an essential operation for generating an avatar. Therefore, it is unclear whether the selection is a selection made randomly since it is essential for generation of an avatar or a selection made for reflecting the user's preference in the avatar. Therefore, with this technique, it is difficult to acquire appropriate psychographic data.

Therefore, an example object of the example embodiments disclosed in the present disclosure is to provide an information processing apparatus, an information processing method, and a program that are capable of appropriately acquiring psychographic data of a user.

In a first example aspect, an information processing apparatus includes:
a modification information acquisition unit configured to acquire modification information being information related to modification of an avatar;
a data estimation unit configured to estimate psychographic data of a user of the avatar, based on the acquired modification information; and
a data output unit configured to output the estimated psychographic data.

In a second example aspect, an information processing method includes:
acquiring modification information being information related to modification of an avatar;
estimating psychographic data of a user of the avatar, based on the acquired modification information; and
outputting the estimated psychographic data.

In a third example aspect, a program causes a computer to execute:
a modification information acquisition step of acquiring modification information being information related to modification of an avatar;
a data estimation step of estimating psychographic data of a user of the avatar, based on the acquired modification information; and a data output step of outputting the estimated psychographic data.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a block diagram illustrating a configuration example of an information processing apparatus according to the present disclosure;

FIG. 2 is a flowchart illustrating an example of an operation flow of the information processing apparatus according to the present disclosure;

FIG. 3 is a block diagram illustrating a configuration example of an information processing system according to the present disclosure;

FIG. 4 is a block diagram illustrating a functional configuration of an information processing apparatus according to the present disclosure;

FIG. 5 is a block diagram illustrating an example of a hardware configuration of the information processing apparatus according to the present disclosure;

FIG. 6 is a block diagram illustrating an example of a hardware configuration of a user terminal according to the present disclosure; and

FIG. 7 is a flowchart illustrating an example of an operation flow of the information processing apparatus according to the present disclosure.

### EXAMPLE EMBODIMENT

### <Outline of the Example Embodiments>

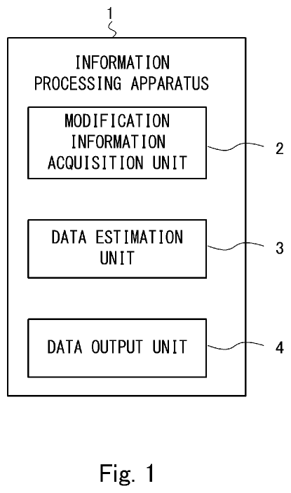

Prior to the detailed description of the example embodiments, an outline of the example embodiments will be described with reference to FIG. 1. As illustrated in FIG. 1, the information processing apparatus 1 includes a modification information acquisition unit 2, a data estimation unit 3, and a data output unit 4.

The modification information acquisition unit 2 acquires modification information being information related to modification of an avatar. Herein, the avatar refers to an agent being used as a user's other self in an application, a virtual space, or the like. The data estimation unit 3 estimates psychographic data of the user of the avatar, based on the modification information acquired by the modification information acquisition unit 2. The psychographic data are data indicating psychological characteristics of the user, and may also be referred to as data indicating characteristics relating to the subjectivity of the user. The data output unit 4 outputs the psychographic data estimated by the data estimation unit 3. The output by the data output unit 4 may be displaying the psychographic data on a display device or transmitting the psychographic data to another device.

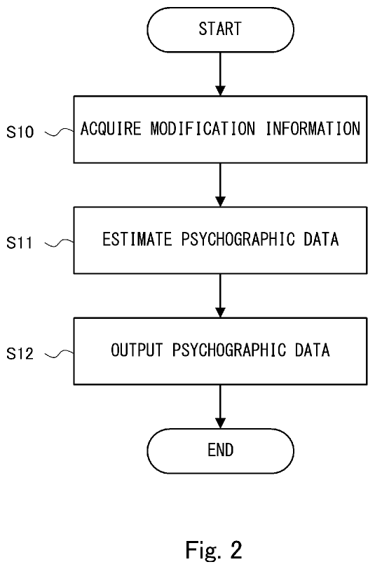

Hereinafter, an example of the operation flow of the information processing apparatus 1 will be described with reference to FIG. 2.

In step S10, the modification information acquisition unit 2 acquires modification information of an avatar.

Next, in step S11, the data estimation unit 3 estimates psychographic data of a user, based on the modification information acquired in step S10.

Next, in step S12, the data output unit 4 outputs the psychographic data estimated in step S11.

In general, the user modifies a component of interest among components of the avatar to reflect their preferences. Therefore, according to the information processing apparatus 1 in which processing of estimating the psychographic data, based on the modification information of the avatar, is performed, it is possible to appropriately acquire the psychographic data of the user.

Hereinafter, the details of the example embodiments will be described.

### First Example Embodiment

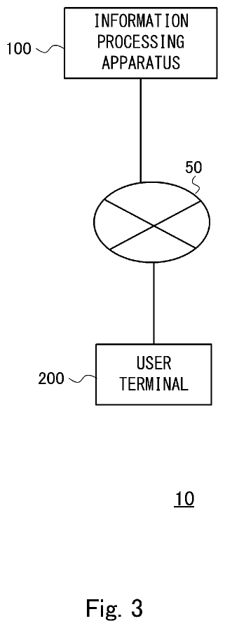

An information processing system 10 according to the first example embodiment will be described with reference to FIG. 3. As illustrated in FIG. 3, the information processing system 10 includes an information processing apparatus 100 and a user terminal 200.

In the example illustrated in FIG. 3, the information processing apparatus 100 and the user terminal 200 are communicably connected to each other via a network 50 such as the Internet.

The user terminal 200 is a terminal apparatus used by a user, and is, for example, a smart phone, a tablet terminal, a personal computer (PC), or the like. In the present example embodiment, the user terminal 200 is employed in order for the user to use the information processing apparatus 100.

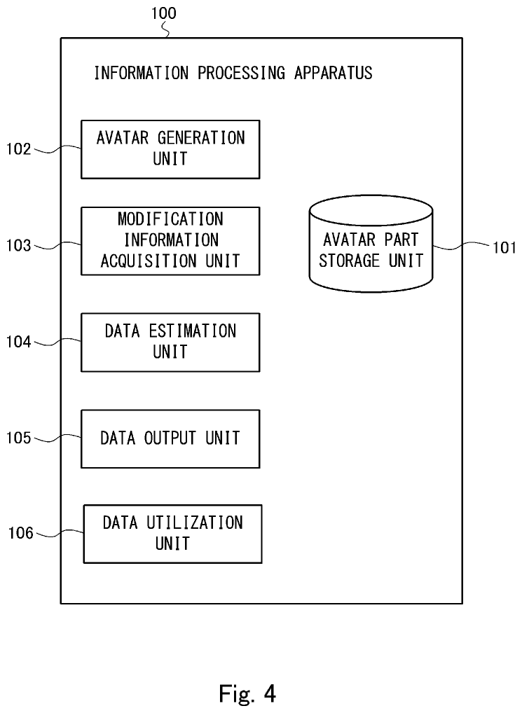

The information processing apparatus 100 is a specific example of the information processing apparatus 1 in FIG. 1, and is an apparatus for estimating psychographic data. More specifically, the information processing apparatus 100 provides a function of generating an avatar, and estimates psychographic data. A functional configuration of the information processing apparatus 100 will be described with reference to FIG. 4. As illustrated in FIG. 4, the information processing apparatus 100 includes an avatar part storage unit 101, an avatar generation unit 102, a modification information acquisition unit 103, a data estimation unit 104, a data output unit 105, and a data utilization unit 106. Note that, all of the components of the information processing apparatus 100 may not be included in a single apparatus, and the components of the information processing apparatus 100 may be distributed among a plurality of apparatuses. That is, the processing of the information processing apparatus 100 may be distributed by a group of apparatuses including a plurality of apparatuses. In such a case, the group of apparatuses may be referred to as an information processing apparatus.

The avatar part storage unit 101 stores data representing parts (hereinafter referred to as part data) for various parts constituting the avatar. The part data are, for example, an image of each part, but may be data of another format. The various parts that constitute the avatar include, but are not limited to, for example, the face, body, hair style, clothing, hat, footwear, personal belongings, accessories, background, and the like. The avatar part storage unit 101 stores part data of different variations for each part. For example, as variations, part data having different colors, shapes, and the like are stored.

The avatar generation unit 102 generates an avatar of the user. In the present example embodiment, as an example, the avatar generation unit 102 generates an avatar by using part data stored in the avatar part storage unit 101. Specifically, the avatar generation unit 102 generates an image of the avatar by, for example, synthesizing part data. The avatar generation unit 102 generates an avatar according to an instruction from the user. Further, the avatar generation unit 102 modifies the avatar according to the user's instruction, and generates a new avatar in which the modification is reflected. Note that the avatar generation unit 102 may generate a default avatar by using part data defined as default part data. Further, the avatar generation unit 102 may generate a default avatar, based on the personal information of the user. For example, the avatar generation unit 102 may generate a default avatar, based on demographic data of the user. In such a case, more specifically, for example, the avatar generation unit 102 generates the default avatar by using part data corresponding to the demographic data of the user among the part data stored in the avatar part storage unit 101. The demographic data are data indicating objective characteristics of the user, such as age, sex, occupation, and the like, and may be also referred to as data based on demographics. Even when a default avatar is generated, the user may modify the default avatar.

In order to modify the avatar, the avatar generation unit 102 acquires an avatar modification instruction from the user. Herein, the avatar modification instruction is an instruction indicating which of the components constituting the avatar is to be modified and how the component is to be modified. For example, the user operates the user terminal 200 to transmit an avatar modification instruction to the information processing apparatus 100. The avatar generation unit 102 that has acquired the modification instruction modifies the avatar in accordance with the modification instruction, and generates a new avatar in which the modification is reflected. As the modification instruction, the user may give an instruction to specify part data to be used for the avatar after modification, or may give an instruction to change the color of a part. Note that these are merely examples of the modification instruction, and the format of the modification instruction is not limited thereto.

The modification information acquisition unit 103 acquires the modification information of the avatar. The modification information may be information related to the modification of the avatar. For example, the modification information may be information indicating whether there is a modification for each component of the avatar. That is, the modification information may be information indicating which of the components constituting the avatar has been instructed to be modified by the user. Further, the modification information may be information indicating the number of times of modification for each component of the avatar.

Further, the modification information may be information indicating a time spent for the modification for each component of the avatar. Herein, the time spent for the modification is the time taken from the start of the modification to the end of the modification when the modification is performed on a certain component, and is determined by determining the start time of the modification operation by the user and the end time of the modification operation. The time spent for the modification is also referred to as a modification time. For example, in a case where the modification instruction is acquired as a set of an instruction specifying a component to be modified and an instruction indicating how to modify the component to be modified, the modification time may be determined as follows. In such a case, for example, the modification time may be a time period from when an instruction specifying a component to be modified is acquired from the user to when an instruction indicating how to modify the component to be modified is acquired from the user. Note that, the above-described determination method is merely an example of a method for determining the modification time, and is not limited to the above-described method, and can be determined by any method.

Further, the modification information may be information indicating a feature determined from a component before modification of the avatar or a feature determined from a component after modification of the avatar. In such a case, the modification information may be information indicating addition or deletion of a feature. Herein, the feature determined from the component need only to be a feature related to the component, and may be an object represented by the component, a category to which the object belongs, a design (shape) of the object, or a color of the component. Further, the modification information may be information indicating the magnitude of a difference between the component before modification of the avatar and the component after modification of the avatar. That is, the modification information may be information indicating the magnitude of a change in a component to be modified. The magnitude of the above-described difference may be, for example, a change amount of the color or a change amount of the shape of the component.

The modification information acquisition unit 103 may acquire the modification information from a history of the modification instruction, that is, the operation log of the user's operation for modifying the avatar. Further, the modification information acquisition unit 103 may acquire the modification information by comparing the avatar at a first time point with the avatar at a second time point after the first time point. For example, the modification information may be acquired by comparing images of the avatar at the first time point and at the second time point. Thus, even when the operation log is not acquired, the modification information can be acquired. Herein, the first time point and the second time point need only to be different timings, and are not limited to a specific time point. That is, the avatar at the first time point may be a default avatar, an avatar in the middle of the modification operation by the user, or an avatar after the generation processing performed by the avatar generation unit 102 is temporary completed, that is, an avatar that is already in use as the avatar of the user. Further, the avatar at the second time point may be an avatar in the middle of the modification operation by the user, or may be an avatar that is already in use as the avatar of the user. For example, the modification information acquisition unit 103 determines the presence or absence of modification for each component of the avatar by comparing the avatar at the first time point with the avatar at the second time point. Further, for example, the modification information acquisition unit 103 determines the number of times of modification for each component of the avatar by repeating the comparison of the avatars at predetermined time intervals. Further, for example, the modification information acquisition unit 103 compares the component of the avatar at the first time point with the component of the avatar at the second time point, and determines the magnitude of the difference between the component before the modification and the component after the modification with respect to the modified component. Further, for example, the modification information acquisition unit 103 determines the component to be modified by comparing the component of the avatar at the first time point with the component of the avatar at the second time point. Then, the modification information acquisition unit 103 determines the feature determined from the component before modification, based on the component of the avatar at the first time point. Similarly, the modification information acquisition unit 103 determines the feature determined from the component after modification, based on the component of the avatar at the second time point.

The data estimation unit 104 estimates the psychographic data of the user who has made the modification to the avatar, based on the modification information acquired by the modification information acquisition unit 103. The data estimation unit 104 may estimate, as the psychographic data of the user, psychographic data indicating that the user is interested in the component to be modified. Further, the data estimation unit 104 may estimate, as the psychographic data of the user, psychographic data indicating that the user prefers the feature determined from the component after modification. In such a case, the psychographic data related to the feature determined from the component after modification may be estimated. For example, in a case where the color of the component is changed to [bright red] by the modification, not only psychographic data of [the color red is preferred] but also psychographic data indicating that the user is passionate may be estimated. Alternatively, the data estimation unit 104 may estimate, as the psychographic data of the user, psychographic data indicating that the feature determined by the component before modification is not preferred.

For example, the data estimation unit 104 estimates psychographic data indicating that the user is interested in the component to be modified by using modification information indicating whether there is a modification for each component of the avatar. Specifically, for example, psychographic data indicating interest in the face, body, hairstyle, clothing, hat, footwear, personal belongings, accessories, or the like is estimated. However, these are merely examples, and psychographic data indicating interests in other components may be estimated. The data estimation unit 104 may estimate the above-described psychographic data by using modification information indicating the number of times of modification for each component of the avatar. In such a case, the data estimation unit 104 may estimate the above-described psychographic data with respect to the components the number of times of modification of which is equal to or more than a predetermined threshold value. Further, when estimating the above-described psychographic data, the data estimation unit 104 may determine the magnitude of the degree of interest in the components in accordance with the number of times of modification. Specifically, for example, the data estimation unit 104 may determine the magnitude of the degree of interest in such a way that the degree of interest increases as the number of times of modification increases. In general, when the number of times of modification is large, the user tends to be highly interested in the component to be modified. Therefore, the psychographic data can be estimated more appropriately by performing the estimation by using the modification information indicating the number of times of modification.

Further, the data estimation unit 104 may estimate psychographic data indicating that the user is interested in the component to be modified by using modification information indicating the modification time for each component of the avatar. In such a case, the data estimation unit 104 may estimate the above-described psychographic data with respect to the component the modification time of which is equal to or more than a predetermined threshold value. Further, when estimating the above-described psychographic data, the data estimation unit 104 may determine the magnitude of the degree of interest in the components in accordance with the modification time. Specifically, for example, the data estimation unit 104 may determine the magnitude of the degree of interest in such a way that the degree of interest increases as the modification time increases. In general, when the modification time is large, the user tends to be highly interested in the component to be modified. Therefore, by performing the estimation by using the modification information indicating the modification time, the psychographic data may be estimated more appropriately.

Further, the data estimation unit 104 may estimate psychographic data indicating that the user is interested in the component to be modified by using modification information indicating the magnitude of the difference between the component before the modification of the avatar and the component after the modification of the avatar. Further, when estimating the psychographic data in such a manner, the data estimation unit 104 may determine the magnitude of the degree of interest to the components in accordance with the magnitude of the difference. For example, for components that are of high interest to the user, it is assumed that the user may be concerned with even minor differences in the components. Therefore, the data estimation unit 104 may determine the magnitude of the degree of interest in such a way that the smaller the difference between the component before the modification of the avatar and the component after the modification of the avatar, the larger the degree of interest.

Further, for example, the data estimation unit 104 may estimate psychographic data indicating that a feature (for example, a color or the like) determined from the component after modification is preferred by using the modification information indicating the feature determined from the component after modification. Similarly, the data estimation unit 104 may estimate psychographic data indicating that a feature determined from the component before modification is not preferred by using the modification information indicating the feature determined from the component before the modification.

Further, the data estimation unit 104 may estimate psychographic data indicating that a feature determined from the component after modification is preferred, by using modification information indicating the feature determined from the component after modification and the number of times of modification of such a component. In such a case, the data estimation unit 104 may estimate the above-described psychographic data when the number of modifications is equal to or more than a predetermined threshold value. Further, when estimating the above-described psychographic data, the data estimation unit 104 may determine the magnitude of the degree of preference for the feature in accordance with the number of times of modification. Specifically, for example, the data estimation unit 104 may determine the degree of preference in such a way that the degree of preference increases as the number of times of modification increases.

Further, the data estimation unit 104 may estimate psychographic data indicating that a feature determined from the component after modification is preferred, by using modification information indicating the feature determined from the component after modification and the modification time of such a component. In such a case, the data estimation unit 104 may estimate the above-described psychographic data when the modification time is equal to or more than a predetermined threshold value. Further, when estimating the above-described psychographic data, the data estimation unit 104 may determine the magnitude of the degree of preference for the feature in accordance with the modification time. Specifically, for example, the data estimation unit 104 may determine the degree of preference in such a way that the degree of preference increases as the modification time increases.

Further, the data estimation unit 104 may estimate the psychographic data by using modification information indicating the feature determined from the component after the modification and the magnitude of the difference between the component before the modification of the avatar and the component after the modification of the avatar. Specifically, the data estimation unit 104 estimates psychographic data indicating that the feature determined from the component after the modification is preferred. At this time, the data estimation unit 104 determines the magnitude of the degree of preference for the feature in accordance with the magnitude of the difference. Specifically, for example, the data estimation unit 104 may determine the degree of preference in such a way that the smaller the difference, the larger the degree of preference. This is because that, for particularly preferred features, it is assumed that the user may be concerned with even small differences.

Further, the data estimation unit 104 may estimate the psychographic data by using a machine learning model. In such a case, for example, the data estimation unit 104 performs estimation processing by using a machine learning model trained in advance using, as training data, data in which modification information of when the user modifies an avatar and known psychographic data related to the user are associated with each other. As a result, psychographic data statistically paired to the modification information are estimated.

The data output unit 105 outputs the psychographic data estimated by the data estimation unit 104 to a predetermined output destination. When the information processing apparatus 100 includes a display device such as a flat panel display, the data output unit 105 may output the estimated psychographic data to the display device. Further, the data output unit 105 may output (i.e., transmit) the estimated psychographic data to an apparatus or a system external to the information processing apparatus 100. In such a case, the external apparatus or system performs processing utilizing the received psychographic data. In the present example embodiment, since the information processing apparatus 100 includes the data utilization unit 106, the data output unit 105 outputs the psychographic data to the data utilization unit 106, but the data utilization unit 106 may be provided in an apparatus or a system external to the information processing apparatus 100.

The data utilization unit 106 performs processing utilizing the estimated psychographic data. For example, the data utilization unit 106 selects a product or a service to be recommended to the user of the avatar by using the estimated psychographic data. Herein, the user of the avatar is a user who has made the modification to the avatar, and can also be said to be a user who uses the avatar. Based on the psychographic data, the data utilization unit 106 selects a product or a service that the user is interested in or a product or a service that the user prefers, from among a product group or a service group. Then, the data utilization unit 106 performs processing of recommending the selected product or service to the user. The processing of recommending a product or a service may be processing of transmitting an advertisement of the product or the service to the user terminal 200.

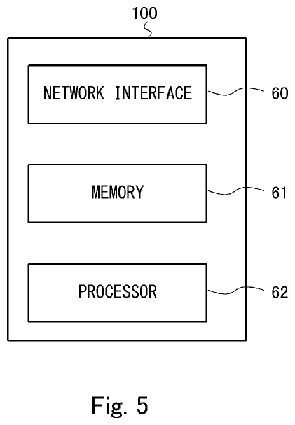

Next, an example of a hardware configuration of the information processing apparatus 100 and the user terminal 200 will be described. An example of a hardware configuration of the information processing apparatus 100 will be described with reference to FIG. 5. The information processing apparatus 100 includes a network interface 60, a memory 61, and a processor 62.

The network interface 60 is being used for communication via the network 50. The network interface 60 may include, for example, a network interface card (NIC).

The memory 61 includes, for example, a combination of a volatile memory and a non-volatile memory. The memory 61 is being used for storing programs to be executed by the processor 62, data to be used for processing, and the like. The avatar part storage unit 101 described above may be achieved by a storage device such as the memory 61 of the information processing apparatus 100.

The processor 62 performs processing of the information processing apparatus 100 by reading and executing a program from the memory 61. The processing of the avatar generation unit 102, the modification information acquisition unit 103, the data estimation unit 104, the data output unit 105, and the data utilization unit 106 described above are performed, for example, by the processor 62 reading and executing a program from the memory 61. The processor 62 may be, for example, a microprocessor, a microprocessor unit (MPU), a central processing unit (CPU), or the like. The processor 62 may include a plurality of processors.

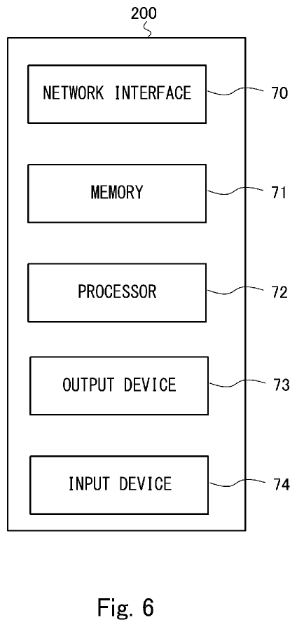

An example of a hardware configuration of the user terminal 200 will be described with reference to FIG. 6. The user terminal 200 includes a network interface 70, a memory 71, a processor 72, an output device 73, and an input device 74.

The network interface 70 is being used for communication via the network 50. The network interface 70 may include, for example, a network interface card (NIC).

The memory 71 includes, for example, a combination of a volatile memory and a non-volatile memory. The memory 71 is being used for storing programs to be executed by the processor 72, data to be used for processing, and the like. The processor 72 performs processing of the user terminal 200 by reading and executing a program from the memory 71. The processor 72 may be, for example, a microprocessor, an MPU, a CPU, or the like. The processor 72 may include a plurality of processors.

The output device 73 is an output device such as a display that outputs information to the outside. The display may be, for example, a flat panel display such as a liquid crystal display, a plasma display, or an organic electroluminescence (EL) display. The avatar generation unit 102 may transmit the generated image of the avatar to the user terminal 200, and in such a case, the output device 73 may display the received image of the avatar. In addition, the avatar generation unit 102 may provide a graphical user interface (GUI) for generating an avatar to the user terminal 200, and the output device 73 may display the GUI. Further, the data output unit 105 may transmit the estimated psychographic data to the user terminal 200, and in such a case, the output device 73 may display the received psychographic data.

The input device 74 is a device for a user to perform input, and is an input device including a pointing device and the like. The input device 74 and the output device 73 may be integrally configured as a touch panel. The input device 74 may include a device other than a pointing device, such as a keyboard.

As described above, the information processing apparatus 100 and the user terminal 200 have functions as a computer. When the program is read by the computer, the program includes instructions (or software codes) for causing the computer to execute one or more functions described in the example embodiment. The program may be stored in a non-transitory computer-readable medium or a tangible recording medium. Although not limited thereto, examples of the computer-readable medium or the tangible recording medium include a random-access memory (RAM), a read-only memory (ROM), a flash memory, a solid-state drive (SSD), or other memory techniques, a CD-ROM, a digital versatile disc (DVD), a Blu-ray (registered trade name) disc, or other optical disc storages, a magnetic cassette, a magnetic tape, a magnetic disc storage, and other magnetic storage devices. The program may be sent on a transitory computer-readable medium or a communication medium. Although not limited thereto, examples of the transitory computer-readable medium or the communication medium include electrical, optical, acoustic, or other forms of propagating signals.

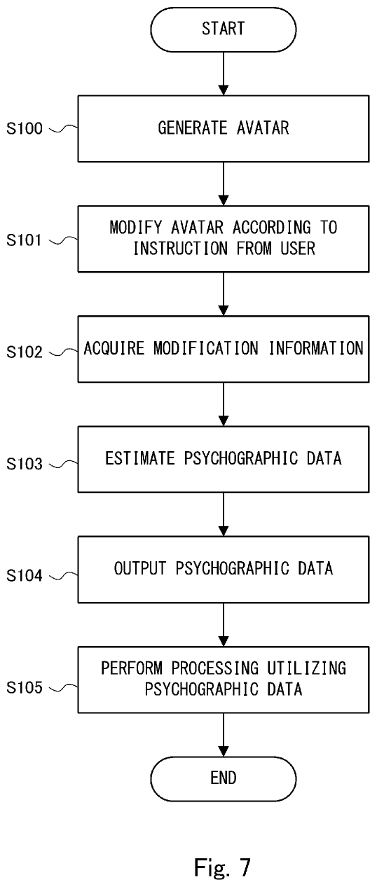

Next, an operation of the information processing apparatus 100 according to the present example embodiment will be described. Hereinafter, an example of the operation flow of the information processing apparatus 100 will be described with reference to FIG. 7.

In step S100, the avatar generation unit 102 generates an avatar of the user. The avatar generated in step S100 may be a default avatar or an avatar generated based on a user's instruction.

Next, in step S101, the avatar generation unit 102 modifies the avatar according to the user's instruction. The user makes a desired modification to the avatar generated in step S100, that is, to the avatar generated in the past.

Next, in step S102, the modification information acquisition unit 103 acquires the modification information of the avatar. That is, the modification information acquisition unit 103 acquires information related to the modification performed in step S101.

Next, in step S103, the data estimation unit 104 estimates the psychographic data of the user, based on the modification information acquired in step S102.

Next, in step S104, the data output unit 105 outputs the psychographic data estimated in step S103 to a predetermined output destination (in the present example embodiment, the data utilization unit 106).

Next, in step S105, the data utilization unit 106 performs predetermined processing utilizing the psychographic data.

The first example embodiment has been described above. According to the information processing apparatus 100, psychographic data are estimated by paying attention to the modification of the avatar performed by the user. In general, since the user modifies the avatar according to his/her interest or preference, the information processing apparatus 100 may appropriately acquire the psychographic data of the user.

### Second Example Embodiment

Next, a second example embodiment will be described. Hereinafter, differences from the first example embodiment will be described, and description of the same configuration and processing as in the first example embodiment will be omitted as appropriate. In the first example embodiment, the information processing apparatus 100 is included in the information processing system 10 as an apparatus different from the user terminal 200. However, some or all of the functions of the information processing apparatus 100 may be provided in the user terminal 200. In such a case, since the user terminal 200 has the function of the information processing apparatus 100, the user terminal 200 may be referred to as an information processing apparatus.

According to the present example embodiment, the same effects as those of the first example embodiment may be acquired. Further, according to the present example embodiment, since psychographic data may be estimated without using an apparatus other than the user terminal 200, the user can securely acquire his/her own psychographic data.

Although the present disclosure has been described with reference to the example embodiments, the present disclosure is not limited to the above. Various modifications that can be understood by a person skilled in the art within the scope of the disclosure can be made to the configuration and details of the present disclosure.

For example, in the above-described example embodiments, the avatar generation unit 102 generates an avatar by using part data as an example, but the avatar generation unit 102 may generate an avatar using any other technique. That is, an avatar may be generated without using a predetermined part. For example, an avatar may be generated by using any artificial intelligence (AI) technique. Further, for example, a modification instruction of the avatar from the user may be an instruction in a natural language such as [Make the hairstyle a little more like a rock'n'roller!]. Then, the avatar generation unit 102 may generate an avatar reflecting such an instruction by using AI technology.

The whole or part of the example embodiments disclosed above can be described as, but not limited to, the following supplementary notes. Some or all of elements (e.g., structures and functions) specified in Supplementary notes 2 to 8 dependent on Supplementary note 1 may also be dependent on Supplementary note 9 and Supplementary note 10 in dependency similar to that of Supplementary notes 2 to 8 on Supplementary note 1. Some or all of elements specified in any of Supplementary notes may be applied to various types of hardware, software, and recording means for recording software, systems, and methods.

### (Supplementary Note 1)

An information processing apparatus including:
a modification information acquisition unit configured to acquire modification information being information related to modification of an avatar;
a data estimation unit configured to estimate psychographic data of a user of the avatar, based on the acquired modification information; and
a data output unit configured to output the estimated psychographic data.

### (Supplementary Note 2)

The information processing apparatus according to supplementary note 1, wherein the modification information includes information indicating whether there is a modification for each component of the avatar.

### (Supplementary Note 3)

The information processing apparatus according to supplementary note 1 or 2, wherein the modification information includes information indicating the number of times of modification for each component of the avatar.

### (Supplementary Note 4)

The information processing apparatus according to any one of supplementary notes 1 to 3, wherein the modification information includes information indicating magnitude of a difference between a component before modification of the avatar and a component after modification of the avatar.

### (Supplementary Note 5)

The information processing apparatus according to any one of supplementary notes 1 to 4, wherein the modification information includes information indicating a feature determined from a component before modification of the avatar or a feature determined from a component after modification of the avatar.

### (Supplementary Note 6)

The information processing apparatus according to any one of supplementary notes 1 to 5, wherein the modification information includes information indicating a modification time for each component of the avatar.

### (Supplementary Note 7)

The information processing apparatus according to any one of supplementary notes 1 to 6, wherein the modification information acquisition unit acquires the modification information by comparing the avatar at a first time point with the avatar at a second time point after the first time point.

### (Supplementary Note 8)

The information processing apparatus according to any one of supplementary notes 1 to 7, further including a data utilization unit configured to select a product or a service to be recommended to a user of the avatar by using the estimated psychographic data.

### (Supplementary Note 9)

An information processing method including:
acquiring modification information being information related to modification of an avatar;
estimating psychographic data of a user of the avatar, based on the acquired modification information; and
outputting the estimated psychographic data.

### (Supplementary Note 10)

A non-transitory computer readable medium storing a program that causes a computer to execute
a modification information acquisition step of acquiring modification information being information related to modification of an avatar;
a data estimation step of estimating psychographic data of a user of the avatar, based on the acquired modification information; and
a data output step of outputting the estimated psychographic data.

According to the present disclosure, it is possible to provide an information processing apparatus, an information processing method, and a program capable of appropriately acquiring psychographic data of a user.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. An information processing apparatus comprising:
at least one memory storing instructions; and
at least one processor configured to execute the instructions to:
acquire modification information being information related to modification of an avatar;
estimate psychographic data of a user of the avatar, based on the acquired modification information; and
output the estimated psychographic data.

2. The information processing apparatus according to claim 1, wherein the modification information includes information indicating whether there is a modification for each component of the avatar.

3. The information processing apparatus according to claim 1, wherein the modification information includes information indicating the number of times of modification for each component of the avatar.

4. The information processing apparatus according to claim 1, wherein the modification information includes information indicating magnitude of a difference between a component before modification of the avatar and a component after modification of the avatar.

5. The information processing apparatus according to claim 1, wherein the modification information includes information indicating a feature determined from a component before modification of the avatar or a feature determined from a component after modification of the avatar.

6. The information processing apparatus according to claim 1, wherein the modification information includes information indicating a modification time for each component of the avatar.

7. The information processing apparatus according to claim 1, wherein the processor is further configured to execute the instructions to acquire the modification information by comparing the avatar at a first time point with the avatar at a second time point after the first time point.

8. The information processing apparatus according to claim 1, wherein the processor is further configured to execute the instructions to select a product or a service to be recommended to a user of the avatar by using the estimated psychographic data.

9. An information processing method comprising:
acquiring modification information being information related to modification of an avatar;
estimating psychographic data of a user of the avatar, based on the acquired modification information; and
outputting the estimated psychographic data.

10. The information processing method according to claim 9, wherein the modification information includes information indicating whether there is a modification for each component of the avatar.

11. The information processing method according to claim 9, wherein the modification information includes information indicating the number of times of modification for each component of the avatar.

12. The information processing method according to claim 9, wherein the modification information includes information indicating magnitude of a difference between a component before modification of the avatar and a component after modification of the avatar.

13. The information processing method according to claim 9, wherein the modification information includes information indicating a feature determined from a component before modification of the avatar or a feature determined from a component after modification of the avatar.

14. The information processing method according to claim 9, wherein the modification information includes information indicating a modification time for each component of the avatar.

15. The information processing method according to claim 9, wherein the modification information is acquired by comparing the avatar at a first time point with the avatar at a second time point after the first time point.

16. The information processing method according to claim 9, wherein the information processing method comprises selecting a product or a service to be recommended to a user of the avatar by using the estimated psychographic data.

17. A non-transitory computer readable medium storing a program that causes a computer to execute:
a modification information acquisition step of acquiring modification information being information related to modification of an avatar;
a data estimation step of estimating psychographic data of a user of the avatar, based on the acquired modification information; and
a data output step of outputting the estimated psychographic data.

18. The non-transitory computer readable medium according to claim 17, wherein the modification information includes information indicating whether there is a modification for each component of the avatar.

19. The non-transitory computer readable medium according to claim 17, wherein the modification information includes information indicating the number of times of modification for each component of the avatar.

20. The non-transitory computer readable medium according to claim 17, wherein the modification information includes information indicating magnitude of a difference between a component before modification of the avatar and a component after modification of the avatar.
